(19) United States
(12) Patent Application Publication
(10) Pub. No.: US 2020/0258259 A1
(43) Pub. Date: Aug. 13, 2020

(54) SCALED CONVERSION OF HUE, SATURATION, LIGHTNESS VALUES TO RED, GREEN, BLUE VALUES

(71) Applicant: QUALCOMM Incorporated, San Diego, CA (US)

(72) Inventor: Manjunath Bajantri, Vishwapriya Nagar (IN)

(21) Appl. No.: 16/272,793

(22) Filed: Feb. 11, 2019

(51) Int. Cl. G06T 7/90; G06T 5/20; G09G 5/06; G09G 5/02; G06K 9/46

(52) U.S. Cl. CPC G06T 7/90; G06T 5/20; G06T 2207/10024; G09G 5/026; G06K 9/4652; G09G 5/06

(57) ABSTRACT

The described techniques relate to improved methods, systems, devices, and apparatuses that support scaled conversion of hue, saturation, lightness (HSL) values to red, green, blue (RGB) values. For example, a device may receive HSL color information, and may convert the HSL color information to RGB color information (e.g., to control a light emitting diode (LED) that is configurable within an RGB color space). In some cases, such a color conversion procedure may include one or more scaling operations to adjust formatting of received color information based on computational capabilities of the device. For example, some devices may be incapable of performing floating point operations, and may scale up received HSL values before conversion of the color information to the RGB color space. The scaled up HSL values may be converted to RGB values, and the RGB values may then be scaled down to set the color of an LED.

### BACKGROUND

The following relates generally to controlling light color at a device, and more specifically to scaled conversion of hue, saturation, lightness (HSL) values to red, green, blue (RGB) values.

Mesh networks may be deployed to provide various types of communication content between devices, such as voice, video, packet data, messaging, broadcast, and so on. In some cases, such a network may include a controlling device (e.g., a remote device, a master device, etc.) and a number of nodes, each simultaneously supporting communication. For example, automation systems are widely deployed to provide various types of functional features such as home fixture control, monitoring, communication, notification, etc. Present automation systems (e.g., for homes and commercial businesses) have become commonplace as people seek to increase control of their property and environment. These systems may employ nodes or sensors at various fixtures (e.g., at lights, curtains, entry and exit points, motion detectors, sound sensors, glass break sensors, etc.) to allow users to monitor and/or control an aspect of a home or business (e.g., via a gateway device or remote control device, such as a user's mobile device).

In some cases, an HSL model may be considered to be a default model for controlling color light in mesh network, such as a Bluetooth mesh network. For some applications, a sensor or node may convert received HSL color space information to other color space information.

### SUMMARY

The described techniques relate to improved methods, systems, devices, and apparatuses that support scaled conversion of hue, saturation, lightness (HSL) values to red, green, blue (RGB) values.

For some applications, a sensor or node may convert received HSL color space information to other color space information. For example, in some cases a sensor or node may receive HSL information and convert the HSL information to an RGB model (e.g., as used in computer monitors and printers). The converted color information may then be output or otherwise used by the sensor or node to control a light emitting diode (LED), a display, etc. In some cases, however, some platforms (e.g., some internet of things (IoT) chipsets) may not support certain formats that may be received from a controlling remote device (e.g., and may obtain flawed results when attempting such conversions from HSL to RGB).

In some cases, a device may perform a color correction or a color conversion (e.g., a conversion of color information from one color space, such as an HSL color space, to another color space, such as an RGB color space) to correct deficiencies in the ability of the device to output or display particular color information. For example, a device may receive HSL color information (e.g., a set of HSL values), and may convert the color information to RGB color information (e.g., a set of RGB values) to control, for example, a light emitting diode (LED) that is configurable within an RGB color space.

In some cases, such a color conversion procedure may include one or more scaling operations to adjust formatting of received color information based on capabilities (e.g., computational capabilities) of the device. For example, some devices (e.g., some platforms) may be incapable of performing floating point operations, and may scale (e.g., scale up) received HSL values before conversion of the color information to the RGB color space. As such, the device may convert the scaled HSL color information to the RGB color space without hardware modification or additional hardware capable of floating point operations (e.g., as floating point operations may otherwise be necessary in the color conversion procedure, depending on the formatting of the received HSL information).

A method of controlling light color at a device is described. The method may include identifying a granularity threshold for a color conversion operation, determining a set of scaling parameters based on the identified granularity threshold, the set of scaling parameters including a minimum boundary value, a maximum boundary value, and at least one scaled constant value, converting a set of hue, saturation, and lightness values to a set of red, green, and blue values based on the set of scaling parameters, and setting a color output of the device based on the set of red, green, and blue values.

An apparatus for controlling light color at a device is described. The apparatus may include a processor, memory in electronic communication with the processor, and instructions stored in the memory. The instructions may be executable by the processor to cause the apparatus to identify a granularity threshold for a color conversion operation, determine a set of scaling parameters based on the identified granularity threshold, the set of scaling parameters including a minimum boundary value, a maximum boundary value, and at least one scaled constant value, convert a set of hue, saturation, and lightness values to a set of red, green, and blue values based on the set of scaling parameters, and set a color output of the device based on the set of red, green, and blue values.

Another apparatus for controlling light color at a device is described. The apparatus may include means for identifying a granularity threshold for a color conversion operation, determining a set of scaling parameters based on the identified granularity threshold, the set of scaling parameters including a minimum boundary value, a maximum boundary value, and at least one scaled constant value, converting a set of hue, saturation, and lightness values to a set of red, green, and blue values based on the set of scaling parameters, and setting a color output of the device based on the set of red, green, and blue values.

A non-transitory computer-readable medium storing code for controlling light color at a device is described. The code may include instructions executable by a processor to identify a granularity threshold for a color conversion operation, determine a set of scaling parameters based on the identified granularity threshold, the set of scaling parameters including a minimum boundary value, a maximum boundary value, and at least one scaled constant value, convert a set of hue, saturation, and lightness values to a set of red, green, and blue values based on the set of scaling parameters, and set a color output of the device based on the set of red, green, and blue values.

Some examples of the method, apparatuses, and non-transitory computer-readable medium described herein may further include operations, features, means, or instructions for scaling the set of hue, saturation, and lightness values based on the maximum boundary value, where the conversion may be based on the scaled set of hue, saturation, and lightness values. Some examples of the method, apparatuses, and non-transitory computer-readable medium described herein may further include operations, features, means, or instructions for scaling the set of red, green, and blue values based on the maximum boundary value, where the setting based on the scaled set of red, green, and blue values.

Some examples of the method, apparatuses, and non-transitory computer-readable medium described herein may further include operations, features, means, or instructions for determining a first scaled constant value of the at least one scaled constant value based on multiplying a first floating point parameter by the maximum boundary value, where the conversion may be based on the first scaled constant value.

In some examples of the method, apparatuses, and non-transitory computer-readable medium described herein, the granularity threshold includes a number of decimal place values associated with an accuracy for the color conversion operation. In some examples of the method, apparatuses, and non-transitory computer-readable medium described herein, the maximum boundary value may be determined based on the number of decimal place values. Some examples of the method, apparatuses, and non-transitory computer-readable medium described herein may further include operations, features, means, or instructions for identifying a floating point operation, where the set of scaling parameters may be determined based on the identified floating point operation.

Some examples of the method, apparatuses, and non-transitory computer-readable medium described herein may further include operations, features, means, or instructions for receiving a hue value, a saturation value, and a lightness value from another device, where the set of hue, saturation, and lightness values includes the hue value, the saturation value, and the lightness value, identifying a maximum hue, saturation, and lightness value based on a number of bits used to indicate at least one of the hue value, the saturation value, or the lightness value, and scaling the set of hue, saturation, and lightness values. In some examples of the method, apparatuses, and non-transitory computer-readable medium described herein, scaling the set of hue, saturation, and lightness values may include operations, features, means, or instructions for multiplying each of the hue value, the saturation value, and the lightness value by a ratio of the maximum boundary value and the maximum hue, saturation, and lightness value, where the conversion may be based on the scaled set of hue, saturation, and lightness values.

### BRIEF DESCRIPTION OF THE DRAWINGS

FIG. 1 illustrates an example of a system for controlling light color at a device that supports scaled conversion of hue, saturation, lightness (HSL) values to red, green, blue (RGB) values in accordance with aspects of the present disclosure.

FIGS. 2 and 3 show block diagrams of devices that support scaled conversion of HSL values to RGB values in accordance with aspects of the present disclosure.

FIG. 4 shows a block diagram of a color manager that supports scaled conversion of HSL values to RGB values in accordance with aspects of the present disclosure.

FIG. 5 shows a diagram of a system including a device that supports scaled conversion of HSL values to RGB values in accordance with aspects of the present disclosure.

FIGS. 6 through 8 show flowcharts illustrating methods that support scaled conversion of HSL values to RGB values in accordance with aspects of the present disclosure.

### DETAILED DESCRIPTION

Mesh networks may be deployed to provide various types of communication content between devices, such as voice, video, packet data, messaging, broadcast, and so on. In some cases, such a network may include a controlling device (e.g., a remote device, a master device, etc.) and a number of nodes, which may in some cases each simultaneously support communication. In some cases, it may be desirable to communicate color information amongst devices (e.g., to remotely control a light emitting diode (LED), a display, etc.).

Color information may be represented in a variety of ways. In some cases, color information may be formatted to represent or indicate color according to some color space. For example, in the red, green, blue (RGB) color space, the color may be defined by a color value that includes a red component, a green component, and blue component. As another example, in the hue, saturation, intensity (HSI), hue, saturation, lightness (HSL), and hue, saturation, value (HSV) color spaces, hue may be a measure of the color content, and saturation may be a measure of vividness (e.g., such as a measure of how pure the color is). Intensity, lightness, and value may relate to a measure of the brightness or darkness of the color. The difference in any of the hue, saturation, or intensity, lightness, or value between two colors may provide a measure of the contrast.

In some cases, an HSL model (e.g., an HSL color space) may be used as a default model for controlling (e.g., communicating) color light in mesh network, such as a Bluetooth mesh network. For some applications, a device (e.g., a sensor, node) may convert received HSL color space information to other color space information. For example, in some cases a device may receive HSL information and convert the HSL information to an RGB model (e.g., as used in computer monitors and printers). The converted color information may then be output or otherwise used by the device to control a light emitting diode (LED), a display, etc. In some cases, however, some device platforms (e.g., some internet of things (IoT) chipsets) may not support certain formats that may be received from a controlling remote device.

For example, some devices, nodes, sensors, etc. may not support floating point operations (e.g., mathematic computations that involve floating point numbers). In cases where floating point HSL information is received by such one or more devices, nodes, sensors, etc., the devices, nodes, sensors, etc. may obtain erroneous results when attempting to convert the HSL information to, for example, the RGB color space (e.g., as a color conversion procedure may include one or more mathematical computations involving the floating point HSL information).

The described techniques generally relate to improved methods, systems, devices, and apparatuses that support scaled conversion of color information from one color space to another, based on the computational capabilities of a device. For example, a device may receive floating point HSL color information (e.g., a set of HSL values), and may scale (e.g., scale up) the received HSL color information for the conversion to RGB color information (e.g., a set of RGB values). The RGB color information may then be scaled (e.g., scaled back down) to ultimately control, for example, an LED that is configurable within an RGB color space. Current platforms (e.g., node, smart LEDs, display processors, etc.) may perform a color correction and/or a color conversion using the described techniques to account for deficiencies in the ability of the device to compute, output, or display particular color information. These devices (e.g., devices incapable of performing floating point operations) may, in some cases, implement the described techniques (e.g., may convert scaled up HSL color information to the RGB color space) without hardware modification (e.g., as floating point operations may otherwise be necessary in the color conversion procedure, depending on the formatting of the received HSL information).

Aspects of the disclosure are initially described in the context of a color control system. Aspects of the disclosure are further illustrated by and described with reference to apparatus diagrams, system diagrams, and flowcharts that relate to scaled conversion of HSL values to RGB values.

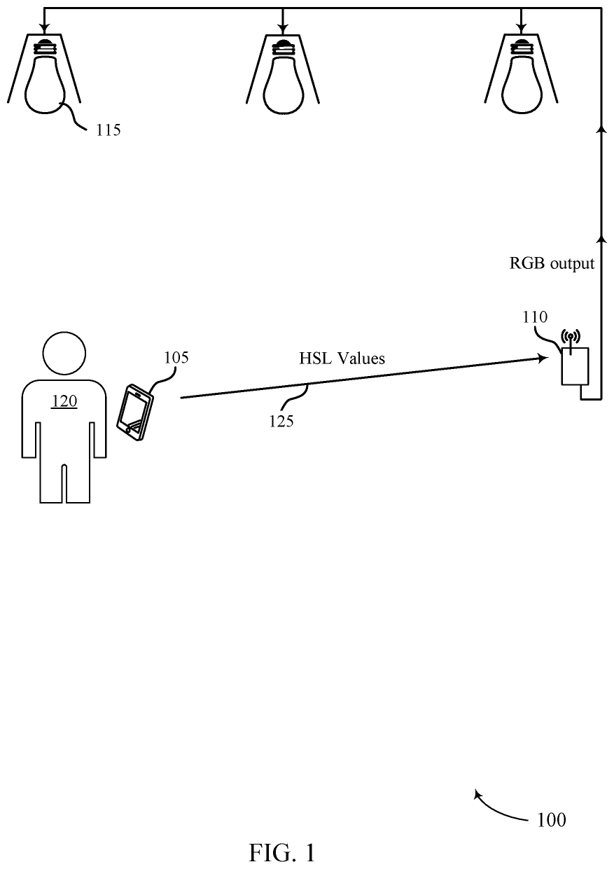

FIG. 1 illustrates an example of a color control system 100 that supports scaled conversion of HSL values to RGB values in accordance with aspects of the present disclosure. The color control system 100 may include at least a remote control device 105 and a device 110. In some cases, the color control system 100 may further include a user 120 (e.g., a user of the remote control device 105, where the remote control device 105 may include a mobile device or personal tablet), as well as one or more LEDs (e.g., light sources 115) controllable by the device 110. In some cases, the device 110 and a light source 115 may be (e.g., included as part of) a single device (e.g., such as a smart LED light bulb). In other cases, one or more light sources 115 may be in communication (e.g., in wireless communication or wired communication) with a separately located device 110.

Techniques described with reference to aspects of color control system 100 are done so for exemplary purposes only, and are not intended to limit the terms of the applicability of the described techniques. That is, the techniques described may be implemented in, or applicable to, other examples of environments with conveyance of color information, by analogy, without departing from the scope of the present disclosure. For example, the described scaling and color conversion techniques may be applied in device display scenarios, device projection scenarios, in scenarios where the device 110 conveys color information to remote control device 105, etc.

As used herein, a remote control device 105 (e.g., a controlling remote device) may be stationary or mobile. A remote control device 105 may also be referred to as a mobile device, a wireless device, a remote device, a handheld device, a subscriber device, or some other suitable terminology. A remote control device 105 may also be a personal electronic device such as a cellular phone, a personal digital assistant (PDA), a tablet computer, a laptop computer, a personal computer, or a display device (e.g., any device with a display or screen). In some examples, a remote control device 105 may also refer to an Internet of Things (IoT) device, an Internet of Everything (IoE) device, a machine type communication (MTC) device, a peer-to-peer (P2P) device, or the like, which may be implemented in various articles such as appliances, vehicles, meters, or the like. For example, in some cases, remote control device 105 may refer to a wall mounted home automation control unit.

As used herein, a device 110 implementing the described scaling and/or color conversion techniques may include or refer to a production platform, a Bluetooth device, a home automation device (e.g., a smart LED light bulb), a personal data assistant (PDA), a printer, copier, scanner, facsimile device, GPS receiver/navigator, camera, MP3 player, camcorder, game console, wrist watch, clock, calculator, television monitor, flat panel display, electronic reading device (e.g., e-reader), computer monitor, auto display (including odometer and speedometer display, etc.), etc. Further examples of devices 110 may include cockpit controls and/or displays, camera view displays (such as the display of a rear view camera in a vehicle), electronic photographs, electronic billboards or signs, projectors, etc.

In some cases, remote control device 105 and device 110 may be in wireless communication. Examples of systems providing such wireless communications may include may include a wireless Personal Area Networks (PAN) (e.g., such as a Bluetooth network), a Wireless Local Area Network (WLAN))(e.g., a Wi-Fi network), fourth generation (4G) systems such as Long Term Evolution (LTE) systems, LTE-Advanced (LTE-A) systems, or LTE-A Pro systems, fifth generation (5G) systems which may be referred to as New Radio (NR) systems, etc. These systems may employ wireless communications technologies such as code division multiple access (CDMA), time division multiple access (TDMA), frequency division multiple access (FDMA), orthogonal frequency division multiple access (OFDMA), discrete Fourier transform-spread-OFDM (DFT-S-OFDM), time division duplexing (TDD), frequency division duplexing (FDD), etc.

For example, wireless PAN communications, such as Bluetooth communications, may allow for short range wireless connections between two or more paired wireless devices (e.g., that have established a wireless communication channel or link). For example, mobile devices such as cellular phones may utilize wireless PAN communications to exchange data such as audio signals with wireless headsets, home automation sensors and devices, etc. Bluetooth communications may thus refer to a short-range communication protocol and may be used to connect and exchange information between a remote control device 105 and a device 110. Bluetooth allows for the creation of a wireless PAN between a master device (e.g., remote control device 105) and one or more slaves devices (e.g., device 110). In some cases, remote control device 105 may refer to a wireless communications device capable of wirelessly exchanging data signals with another device, and device 110 may refer to a device operating in a slave role, or to a short-range wireless device capable of exchanging data signals with the remote control device 105 (e.g., using Bluetooth communication protocols) and, in some cases, other devices (e.g., such as light sources 115).

In some cases, Bluetooth systems (e.g., aspects of color control system 100) may be organized using a master-slave relationship employing a TDD protocol having, for example, defined time slots of 625 mu secs, in which transmission alternates between the master (e.g., remote control device 105) and slave (e.g., device 110). A link 125 may be established between two Bluetooth devices (e.g., between a remote control device 105 and a paired device 110), and may provide for communications or services (e.g., according to some Bluetooth profile).

For example, a Bluetooth connection may be an extended synchronous connection orientated (eSCO) link for voice call (e.g., which may allow for retransmission), an ACL link for music streaming (e.g., A2DP), etc. For example, eSCO packets may be transmitted in predetermined time slots (e.g., 6 Bluetooth slots each for eSCO). The regular interval between the eSCO packets may be specified when the Bluetooth link is established. The eSCO packets to/from a specific slave device are acknowledged, and may be retransmitted if not acknowledged during a retransmission window. In addition, audio may be streamed between a device and a paired device using an ACL link (A2DP profile). In some cases, the ACL link may occupy 1, 3, or 5 Bluetooth slots for data or voice. Other Bluetooth profiles supported by Bluetooth devices may include Bluetooth Low Energy (BLE) (e.g., providing considerably reduced power consumption and cost while maintaining a similar communication range), human interface device profile (HID) (e.g., providing low latency links with low power requirements), etc.

In the example, of FIG. 1, a user 120 may utilize remote control device 105 to control (e.g., set, adjust) the color of light sources 115 (e.g., to control the output of device 110). As discussed above, color control system 100 is illustrated for exemplary purposes, and is not intended to be limiting. In general, the techniques described herein may be implemented by any device converting color information from one color space to another, by any device involved, such as a device in conveyance of color information, etc. In the present example, remote control device 105 may convey (e.g., transmit) HSL color information (e.g., a set of HSL values) to device 110 via link 125 (e.g., a BLE link). The device 110 may convert the HSL color information to the RGB color space (e.g., to RGB color information), and may then set RGB values via firmware application programming interface (API) to change the color of a light source 115 (e.g., to change the color of an LED of the production platform). That is, in some cases, firmware may provide a set of APIs to set the values of the RGB LED. An example of the algorithm that may be implemented on device 110 firmware is described in more detail below.

The set of HSL values (e.g., the set of H, S, and L values) may include a hue (H) value, a saturation (S) value, and a lightness (L) value. In some examples, remote control device 105 may indicate each value via 16 bits. For example, a remote control device 105 may indicate a 16 bit value for hue, a 16 bit value for saturation, and a 16 bit value for lightness. The device 110 may receive the information, and determine a value for the hue, saturation, and lightness values. In some cases, each received value may compared relative to another value (e.g., be divided by the maximum value), to determine each value (e.g., on a scale of 0 to 1). For example, in cases where 16 bits are used for each HSL value, device 110 may convert the received bit string (e.g., for each value) to a decimal number, and may divide that number by 65535 (e.g., the maximum decimal value representable by a 16 bit binary value), thus giving each HSL value within a range of 0 to 1.

However, some devices 110 may not support floating point operations. In such cases, a device 110 may produce erroneous or otherwise inaccurate results when attempting to convert the color information (e.g., with values ranging from 0 to 1) from one color space to another color space. That is, some color conversion algorithms (e.g., such as HSL to RGB conversion algorithms) may utilize floating point operations (e.g., as HSL values may be represented as values ranging from 0 to 1, and mathematical computations may be used within HSL to RGB conversion algorithms).

Some devices that do not support floating point operations may attempt to perform color conversion calculations using fixed point values (e.g., absolute values, decimal conversions of the binary value indications without division by the maximum value, etc.). However, such may result in erroneous or otherwise inaccurate conversion values when processed through some algorithms (e.g., through HSL to RGB conversion algorithms). That is, fixed point operations may be insufficient due to HSL values ranging from 0 to 1.

A scale-up/scale-down approach may be used by such platforms to approximate floating point math results. For example, small floating point numbers (e.g., received HSL values) may be scaled up (e.g., to a 16 bit integer range, a 32 bit integer range), and computation results may then be scaled down (e.g., by the scaling factor used to scale-up). Additionally, the granularity or precision of the color conversion computations may be controlled based on the selection of the scaling factor.

For example, the Bluetooth Mesh Model Specification V1.0 may include an HSL to RGB color conversion algorithm for devices (e.g., in a mesh network) to convert default HSL values to RGB color space (e.g., to convert H, S, and L values to corresponding R, G, and B values). The HSL to RGB color conversion algorithm may include floating point operations, as HSL values may be normalized to fractions between 0 and 1 in some cases. For example, when a device 110 receives each H, S, and L value, the device 110 may convert each bit string to a decimal value and normalize the new value (e.g., by dividing the new value by 65535, which may be the maximum decimal value representable by a 16 bit value. When device 110 does not support floating point operations, the device 110 may compute erroneous results when using such color conversion algorithms. Examples of such platforms (e.g., devices 110 that do not support floating point operations) may include CSR1025-A06 platforms, some versions of flashheart platforms, etc. For such a device 110 to perform such color conversion operations, a device may use scaled conversion techniques described herein.

To arrive at precision values for color conversion operations without performing floating point operations, a device may use a scale up/scale down approach. For example, as some algorithms (e.g., the HSL to RGB color conversion algorithm of the Mesh Model Specification V1.0) demand the H, S, and L values be between 0 to 1, a device 110 may set a minimum boundary (e.g., to 1000) and a maximum boundary value (e.g., to 10000). Depending on the number of decimal digits desired for the precision computation (e.g., the color conversion output), the device 110 may choose a value to scale up the outcome (e.g., of the H, S, and L binary value to decimal value) during the division operations (e.g., a scaling factor of 10000 may be used for up to 4 decimal digit precision). For example, in the algorithm described below: Y=((X*10000)/UINT16_MAX_VALUE), where X may typically be greater than 100, and Y may refer to the scaled up H, S, or L value X. A device 110 further scale up any constants in the color conversion algorithm by the scaling constant. For example, in the algorithm described below: the ⅓ constant would yield 0.3333, and may be scaled by 10000 such that the scaled constant value would be 3333, which may ultimately provide conversion precision up to 4 decimal digits.

Further, if two scaled values are multiplied in a color conversion operation, then device 110 may scale down the resulting value (e.g., device 110 may divide the outcome of any multiplication operation in a color conversion algorithm with the scaling-value). For example, if X and Y are scaled values then X*Y yields very large values to contain for further computation, hence device 110 may divide the outcome of multiplication with the scaling-value. X*Y/10000. Once done with the conversion computation device 110 may scale-down the value (e.g., the values that have been converted to RGB space) to arrive at the final result. In some cases, a device 110 may also ensure the scaled up value doesn't overflow leading to invalid values (e.g., Z=Y/10000).

An example of such an algorithm that may be implemented by a device 110 to convert a set of received HSL values to a set of RGB values may be as follows:

| | |
|---|---|
| #define UINT16_MAX_VALUE | (65535) |
| #define MINIMUM_BOUNDARY_VAL | (1000) |
| #define MAXIMUM_BOUNDARY_VAL | (10000) |
| #define SCALING_UP_VAL | (255) |
| #define SCALED_ONE_DIV_THREE | (3333) |
| #define SCALED_TWO_DIV_THREE | (6666) |

static unsigned long Hue_2_RGB(unsigned long v1, unsigned long v2,
unsigned long vH)
{
if (vH < MINIMUM_BOUNDARY_VAL)
{
vH += MAXIMUM_BOUNDARY_VAL;
}
if (vH > MAXIMUM_BOUNDARY_VAL)
{
vH −= MAXIMUM_BOUNDARY_VAL;
}
if ((6 * vH) < MAXIMUM_BOUNDARY_VAL)
{
return (v1 + (((v2 − v1) * 6 * vH) / MAXIMUM_BOUNDARY_VAL));
}
if ((2 * vH) < MAXIMUM_BOUNDARY_VAL)
{
return (v2);
}
if ((3 * vH) < (MAXIMUM_BOUNDARY_VAL*2))
{
return (v1 + (((v2 − v1) * (SCALED_TWO_DIV_THREE − vH) * 6) /
MAXIMUM_BOUNDARY_VAL));
}
return (v1);
}
static void specHSLAlgo(int32_t hue, int32_t sat, int32_t lig)
{
unsigned long H, S, L;
int32_t r,g,b;
uint8_t R, G, B;
unsigned long var_1, var_2, vH;
H = ((hue * MAXIMUM_BOUNDARY_VAL)/ UINT16_MAX_VALUE);
S = ((sat * MAXIMUM_BOUNDARY_VAL)/ UINT16_MAX_VALUE);
L = ((lig * MAXIMUM_BOUNDARY_VAL)/ UINT16_MAX_VALUE);
if (S == 0)
{
DEBUG_STR(“Saturation is 0\n”);
r = L;
g = L;
b = L;
R = (r * SCALING_UP_VAL)/MAXIMUM_BOUNDARY_VAL;
B = G = R;
}
else
{
if (L < 5000)
{
var_2 = (L * (10000 + S))/MAXIMUM_BOUNDARY_VAL;
}
else
{
var_2 = (L + S) − ((S * L)/MAXIMUM_BOUNDARY_VAL);
}
var_1 = 2 * L − var_2;

vH = (H + SCALED_ONE_DIV_THREE);

r = Hue_2_RGB(var_1, var_2, vH);
vH = H;
g = Hue_2_RGB(var_1, var_2, vH);
vH = (H − SCALED_ONE_DIV_THREE);
b = Hue_2_RGB(var_1, var_2, vH);
R = ((r * 255) / MAXIMUM_BOUNDARY_VAL);
G = ((g * 255) / MAXIMUM_BOUNDARY_VAL);
B = ((b * 255) / MAXIMUM_BOUNDARY_VAL);
}
DEBUG_STR(“\r\nSpecAlgo Red = “);
DEBUG_U8(R);
DEBUG_STR(“ Green = “);
DEBUG_U8(G);
DEBUG_STR(“ Blue = “);
DEBUG_U8(B);
DEBUG_STR(“\r\n”);
}

The algorithm above is an example implementation of a color conversion operation performable by a device 110. The device 110 may receive a set of H, S, and L values from a remote control device 105 (e.g., via link 125, such as a BLE link). The device 110 may then convert the set of H, S, and L values to a set of R, G, and B values (e.g., using the algorithm above, or a similar algorithm based on the description herein). The device 110 may thus set a color output of the device 110 (e.g., of the light source 115) based on the computed set of R, G, and B values.

In some cases, a device 110 may identify a granularity threshold for a color conversion operation. For example, the device 110 may identify a precision desired for the HSL to RGB conversion. The granularity threshold may refer to the desired precision of the conversion (e.g., a maximum number of decimal place values associated with an accuracy for the color conversion operation), precision of the received HSL values, the desired precision of the to be computed RGB values, a precision specification of a light source 115 input, a precision specification of some other color operation, etc. For example, a granularity threshold may refer to a desired precision of R, G, and B output values. For example, a device 110 may desire R, G, and B output values with a granularity of 4 decimal digits.

Device 110 may then determine a set of scaling parameters based at least in part on the identified granularity threshold. The set of scaling parameters may include a minimum boundary value (e.g., MINIMUM_BOUNDARY_VAL), a maximum boundary value (e.g., MAXIMUM_BOUNDARY_VAL), and at least one scaled constant value (e.g., SCALED_ONE_DIV_THREE, SCALED_TWO_DIV_THREE, etc.). For instance, in the example above where the device 110 identifies a granularity threshold of 4 decimal digits or 4 decimal place values associated with an accuracy for the color conversion operation, a minimum boundary value and a maximum boundary value may be determined such that the values are bound between two values, such as 1000 and 10000. Further, in this example, any constants in a color conversion algorithm (e.g., ⅓ and ⅔ in the HSL to RGB color conversion algorithm of the Bluetooth Mesh Model Specification V1.0) may be similarly determined based on the granularity threshold of 4 (e.g., ⅓ may be scaled to 3333, and ⅔ may be scaled to 6666, as 3333 is ⅓ in the 1000 to 10000 range and 6666 is ⅔ in the 1000 to 10000 range). In general, a device 110 may determine a scaled constant for a color conversion operation by multiplying any floating point parameters of a color conversion algorithm by the determined maximum boundary value (e.g., and may then perform the color conversion using the scaled constant value(s)).

In some cases, the set of scaling parameters may depend on a scaling factor (e.g., the minimum boundary value, the maximum boundary value, and the at least one scaled constant value may be derived from a scaling factor). In some cases, the scaling factor may be determined based on the identified granularity threshold. Further, in some cases, device 110 may identify a floating point operation (e.g., device 110 may identify a color conversion operation includes floating point operations), and may determine the set of scaling parameters based on that identification.

The device 110 may then convert the set of HSL values to a set of RGB values based on the set of scaling parameters (e.g., as shown in the example algorithm above). For example, the device 110 may scale up the set of H, S, and L values based at least in part on the maximum boundary value, wherein the conversion is then performed on the scaled set of H, S, and L values. The device 110 may then scale down the computed set of R, G, and B values based at least in part on the maximum boundary value (e.g., and may set the color output based at least in part on the scaled down set of R, G, and B values).

For example, device 110 may identify a maximum H, S, and L value based at least in part on a number of bits used to indicate at least one of the hue value, the saturation value, or the lightness value. In the example algorithm above, the number of bits used by remote control device 105 to convey each H, S, and L value may be 16 bits. In such cases, the device 110 may identify a maximum H, S, and L value (UINT16_MAX_VALUE) of 65535. The device 110 may then multiply each of the hue value, the saturation value, and the lightness value by a ratio of the maximum boundary value and the maximum H, S, and L value, wherein the conversion is based at least in part on the scaled set of H, S, and L values. For example, in the algorithm above, H may be ((hue*MAXIMUM_BOUNDARY_VAL)/UINT16_MAX_VALUE), S may be ((sat*MAXIMUM_BOUNDARY_VAL)/UINT16_MAX_VALUE), and L may be ((lig*MAXIMUM_BOUNDARY_VAL)/UINT16_MAX_VALUE), where H, S, and L represent the scaled up set of hue, sat, and lig values received by a device 110.

As discussed above, the techniques described herein are done so for exemplary purposes only, and are not intended to be limiting in terms of the applicability of the described techniques. For example, in some cases, a device may, by analogy, scale down received color information before converting the color information to another color space, and may then scale up the converted color information. In general, a device may, by analogy, scale received color information before converting the color information to another color space based on some desired range of the color conversion inputs, some computation capabilities of the device, some desired range of the color conversion outputs, etc. The granularity of color conversion computations may be selected by a platform (e.g., or device) based on the value used for scaling, and the granularity and/or scaling may be selected based on the support provided by the platform.

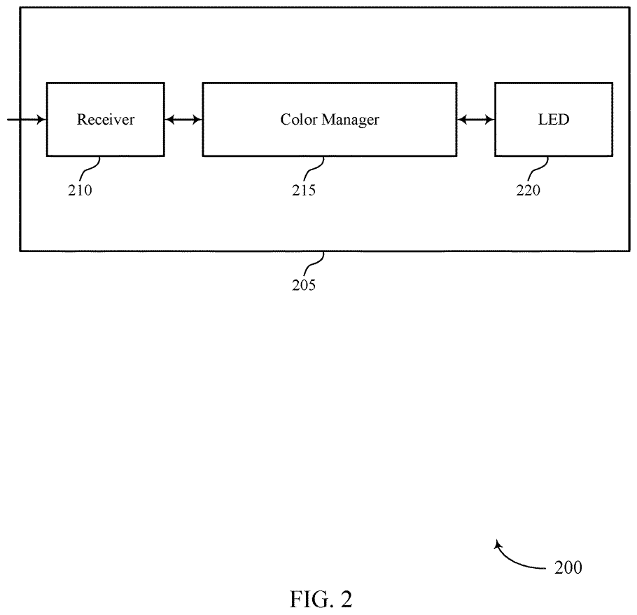

FIG. 2 shows a block diagram 200 of a device 205 that supports scaled conversion of HSL values to RGB values in accordance with aspects of the present disclosure. The device 205 may be an example of aspects of a device as described herein. The device 205 may include a receiver 210, a color manager 215, and an LED 220. The device 205 may also include a processor. Each of these components may be in communication with one another (e.g., via one or more buses). In some cases, a device 205 may be referred to as a production platform, a smart LED light bulb, etc.

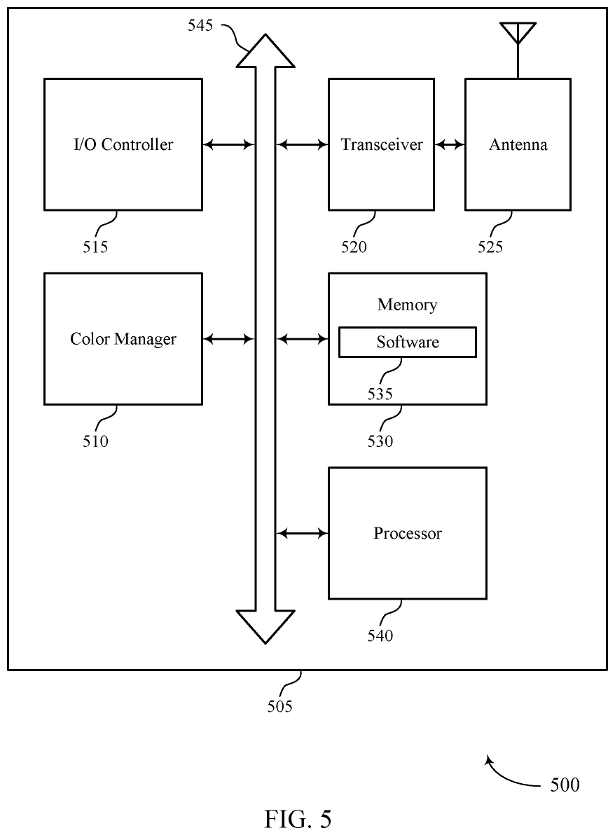

The receiver 210 may receive information such as packets, user data, or control information associated with various information channels (e.g., control channels, data channels, and information related to scaled conversion of HSL values to RGB values, etc.). Information may be passed on to other components of the device 205. For example, the receiver 210 may receive a set of H, S, and L values, and may pass the values to the color manager 215. The receiver 210 may be an example of aspects of the transceiver 520 described with reference to FIG. 5. The receiver 210 may utilize a single antenna or a set of antennas.

The color manager 215 may identify a granularity threshold for a color conversion operation, determine a set of scaling parameters based on the identified granularity threshold, the set of scaling parameters including a minimum boundary value, a maximum boundary value, and at least one scaled constant value, convert a set of hue, saturation, and lightness values to a set of red, green, and blue values based on the set of scaling parameters, and set a color output of the device based on the set of red, green, and blue values. The color manager 215 may be an example of aspects of the color manager 510 described herein.

The color manager 215, or its sub-components, may be implemented in hardware, code (e.g., software or firmware) executed by a processor, or any combination thereof. If implemented in code executed by a processor, the functions of the color manager 215, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The color manager 215, or its sub-components, may be physically located at various positions, including being distributed such that portions of functions are implemented at different physical locations by one or more physical components. In some examples, the color manager 215, or its sub-components, may be a separate and distinct component in accordance with various aspects of the present disclosure. In some examples, the color manager 215, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The LED 220 may receive a set of R, G, and B values (e.g., a scaled down set of R, G, and B values that have been converted from scaled up H, S, and L values) from the color manager 215. The LED 220 may illuminate according to the set of R, G, and B values (e.g., the color of the LED 220 may depend on the set of R, G, and B values). The LED 220 is illustrated as being included in the device 205, however, in some cases, the LED 220 and the device 205 may be separately located (e.g., as described with reference to FIG. 1). Further, LED 220 may be replaced or substituted for other components of a device that may receive color information. For example, in some cases, LED 220 may be an array of LED of an LED display, some other display, etc. In some cases, the LED 220 may be an example of aspects of the I/O controller 515 described with reference to FIG. 5.

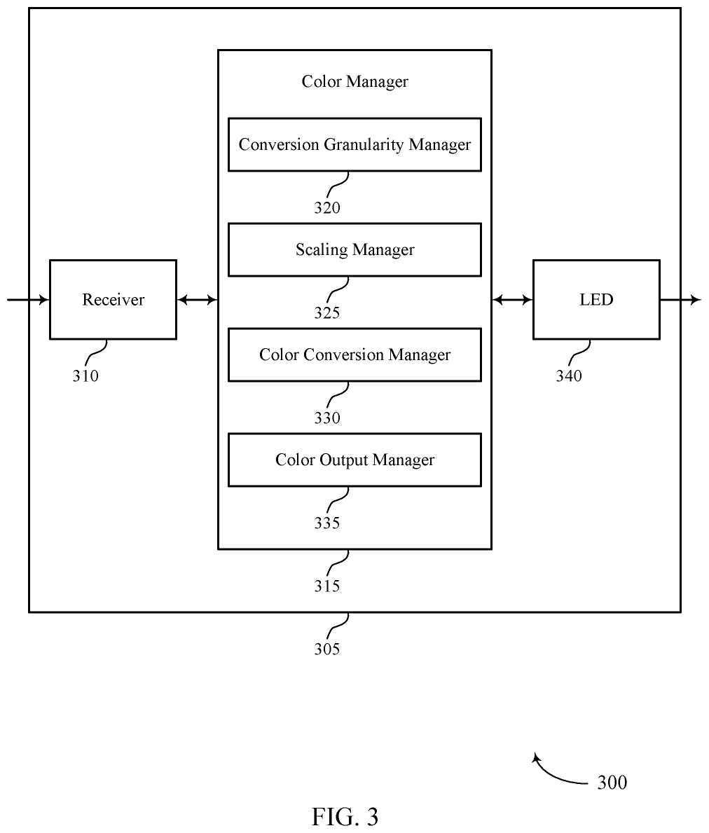

FIG. 3 shows a block diagram 300 of a device 305 that supports scaled conversion of HSL values to RGB values in accordance with aspects of the present disclosure. The device 305 may be an example of aspects of a device 205 or a device 110 as described herein. The device 305 may include a receiver 310, a color manager 315, and an LED 340. The device 305 may also include a processor. Each of these components may be in communication with one another (e.g., via one or more buses).

The receiver 310 may receive information such as packets, user data, or control information associated with various information channels (e.g., control channels, data channels, and information related to scaled conversion of HSL values to RGB values, etc.). Information may be passed on to other components of the device 305. For example, the receiver 310 may receive a set of H, S, and L values, and may pass the values to the color manager 315. The receiver 310 may be an example of aspects of the transceiver 520 described with reference to FIG. 5. The receiver 310 may utilize a single antenna or a set of antennas.

The color manager 315 may be an example of aspects of the color manager 215 as described herein. The color manager 315 may include a conversion granularity manager 320, a scaling manager 325, a color conversion manager 330, and a color output manager 335. The color manager 315 may be an example of aspects of the color manager 510 described herein.

The conversion granularity manager 320 may identify a granularity threshold for a color conversion operation. The scaling manager 325 may determine a set of scaling parameters based on the identified granularity threshold, the set of scaling parameters including a minimum boundary value, a maximum boundary value, and at least one scaled constant value. The color conversion manager 330 may convert a set of hue, saturation, and lightness values to a set of red, green, and blue values based on the set of scaling parameters. The color output manager 335 may set a color output of the device based on the set of red, green, and blue values (e.g., in some cases, setting the color output may refer to passing the set of R, G, and B values to the LED 340).

The LED 340 may receive a set of R, G, and B values (e.g., a scaled down set of R, G, and B values that have been converted from scaled up H, S, and L values) from the color manager 315. The LED 340 may illuminate according to the set of R, G, and B values (e.g., the color of the LED 340 may depend on the set of R, G, and B values). In some cases, setting the color output may refer to the LED 340 illuminating according to the set of R, G, and B values. The LED 340 is illustrated as being included in the device 305, however, in some cases, the LED 340 and the device 305 may be separately located (e.g., as described with reference to FIG. 1). Further, LED 340 may be replaced or substituted for other components of a device that may receive color information. For example, in some cases, LED 340 may be an array of LED of an LED display, some other display, etc. In some cases, the LED 340 may be an example of aspects of the I/O controller 515 described with reference to FIG. 5.

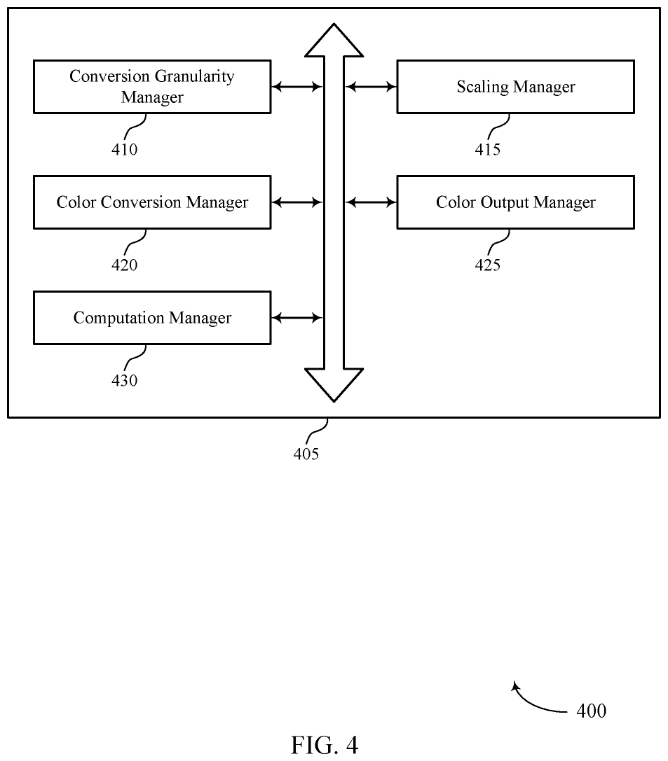

FIG. 4 shows a block diagram 400 of a color manager 405 that supports scaled conversion of HSL values to RGB values in accordance with aspects of the present disclosure. The color manager 405 may be an example of aspects of a color manager 215, a color manager 315, or a color manager 510 described herein. The color manager 405 may include a conversion granularity manager 410, a scaling manager 415, a color conversion manager 420, a color output manager 425, and a computation manager 430. Each of these modules may communicate, directly or indirectly, with one another (e.g., via one or more buses).

The conversion granularity manager 410 may identify a granularity threshold for a color conversion operation. In some cases, the granularity threshold includes a number of decimal place values associated with an accuracy for the color conversion operation.

The scaling manager 415 may determine a set of scaling parameters based on the identified granularity threshold, the set of scaling parameters including a minimum boundary value, a maximum boundary value, and at least one scaled constant value. In some cases, the maximum boundary value is determined based on the number of decimal place values.

In some examples, the scaling manager 415 may scale the set of hue, saturation, and lightness values based on the maximum boundary value, where the conversion is based on the scaled set of hue, saturation, and lightness values. In some examples, the scaling manager 415 may scale the set of red, green, and blue values based on the maximum boundary value, where the setting based on the scaled set of red, green, and blue values. In some examples, the scaling manager 415 may determine a first scaled constant value of the at least one scaled constant value based on multiplying a first floating point parameter by the maximum boundary value, where the conversion is based on the first scaled constant value. In some examples, the scaling manager 415 may identify a maximum hue, saturation, and lightness value based on a number of bits used to indicate at least one of the hue value, the saturation value, or the lightness value. In some examples, the scaling manager 415 may scale the set of hue, saturation, and lightness values. In some examples, the scaling manager 415 may multiply each of the hue value, the saturation value, and the lightness value by a ratio of the maximum boundary value and the maximum hue, saturation, and lightness value, where the conversion is based on the scaled set of hue, saturation, and lightness values.

The color conversion manager 420 may convert a set of hue, saturation, and lightness values to a set of red, green, and blue values based on the set of scaling parameters. The color output manager 425 may set a color output of the device based on the set of red, green, and blue values. In some examples, receiving a hue value, a saturation value, and a lightness value from another device, where the set of hue, saturation, and lightness values includes the hue value, the saturation value, and the lightness value.

The computation manager 430 may identify a floating point operation, where the set of scaling parameters is determined based on the identified floating point operation.

FIG. 5 shows a diagram of a system 500 including a device 505 that supports scaled conversion of HSL values to RGB values in accordance with aspects of the present disclosure. The device 505 may be an example of or include the components of device 205, device 305, or a device as described herein. The device 505 may include components for bi-directional voice and data communications including components for transmitting and receiving communications, including a color manager 510, an I/O controller 515, a transceiver 520, an antenna 525, memory 530, and a processor 540. These components may be in electronic communication via one or more buses (e.g., bus 545).

The color manager 510 may identify a granularity threshold for a color conversion operation, determine a set of scaling parameters based on the identified granularity threshold, the set of scaling parameters including a minimum boundary value, a maximum boundary value, and at least one scaled constant value, convert a set of hue, saturation, and lightness values to a set of red, green, and blue values based on the set of scaling parameters, and set a color output of the device based on the set of red, green, and blue values.

The I/O controller 515 may manage input and output signals for the device 505. The I/O controller 515 may also manage peripherals not integrated into the device 505. In some cases, the I/O controller 515 may represent a physical connection or port to an external peripheral. In some cases, the I/O controller 515 may utilize an operating system such as iOS®, ANDROID®, MS-DOS®, MS-WINDOWS®, OS/2®, UNIX®, LINUX®, or another known operating system. In other cases, the I/O controller 515 may represent or interact with a modem, a keyboard, a mouse, a touchscreen, or a similar device. In some cases, the I/O controller 515 may be implemented as part of a processor. In some cases, a user may interact with the device 505 via the I/O controller 515 or via hardware components controlled by the I/O controller 515.

As discussed above, the I/O controller 515 may in some cases refer to an LED (e.g., an LED 340, an LED 220), for example, when the I/O controller 515 is included in the device 505. However, in some cases, the LED and the device 505 may be separately located and the I/O controller 515 may output converted R, G, and B values to the LED (e.g., via some wired interface). In other examples, the device 505 may include a transmitter that may transmit signals generated by other components of the device 505. For example, the device 505 may transmit computed RGB values to an LED (e.g., to set the LED). In some examples, the transmitter may be collocated with a receiver in a transceiver module.

The transceiver 520 may communicate bi-directionally, via one or more antennas, wired, or wireless links as described above. For example, the transceiver 520 may represent a wireless transceiver and may communicate bi-directionally with another wireless transceiver. The transceiver 520 may also include a modem to modulate the packets and provide the modulated packets to the antennas for transmission, and to demodulate packets received from the antennas.

In some cases, the wireless device may include a single antenna 525. However, in some cases the device may have more than one antenna 525, which may be capable of concurrently transmitting or receiving multiple wireless transmissions.

The memory 530 may include RAM and ROM. The memory 530 may store computer-readable, computer-executable code or software 535 including instructions that, when executed, cause the processor to perform various functions described herein. In some cases, the memory 530 may contain, among other things, a BIOS which may control basic hardware or software operation such as the interaction with peripheral components or devices.

The processor 540 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 540 may be configured to operate a memory array using a memory controller. In other cases, a memory controller may be integrated into the processor 540. The processor 540 may be configured to execute computer-readable instructions stored in a memory (e.g., the memory 530) to cause the device 505 to perform various functions (e.g., functions or tasks supporting scaled conversion of HSL values to RGB values).

The software 535 may include instructions to implement aspects of the present disclosure, including instructions to support controlling light color at a device. The software 535 may be stored in a non-transitory computer-readable medium such as system memory or other type of memory. In some cases, the software 535 may not be directly executable by the processor 540 but may cause a computer (e.g., when compiled and executed) to perform functions described herein.

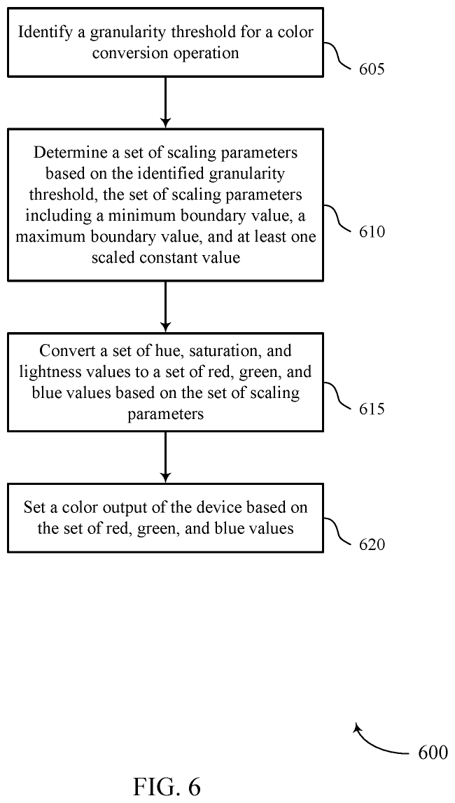

FIG. 6 shows a flowchart illustrating a method 600 that supports scaled conversion of HSL values to RGB values in accordance with aspects of the present disclosure. The operations of method 600 may be implemented by a device or its components as described herein. For example, the operations of method 600 may be performed by a color manager as described with reference to FIGS. 2 through 5. In some examples, a device may execute a set of instructions to control the functional elements of the device to perform the functions described below. Additionally or alternatively, a device may perform aspects of the functions described below using special-purpose hardware.

At 605, the device may identify a granularity threshold for a color conversion operation. The operations of 605 may be performed according to the methods described herein. In some examples, aspects of the operations of 605 may be performed by a conversion granularity manager as described with reference to FIGS. 2 through 5.

At 610, the device may determine a set of scaling parameters based on the identified granularity threshold, the set of scaling parameters including a minimum boundary value, a maximum boundary value, and at least one scaled constant value. The operations of 610 may be performed according to the methods described herein. In some examples, aspects of the operations of 610 may be performed by a scaling manager as described with reference to FIGS. 2 through 5.

At 615, the device may convert a set of hue, saturation, and lightness values to a set of red, green, and blue values based on the set of scaling parameters. The operations of 615 may be performed according to the methods described herein. In some examples, aspects of the operations of 615 may be performed by a color conversion manager as described with reference to FIGS. 2 through 5.

At 620, the device may set a color output of the device based on the set of red, green, and blue values. The operations of 620 may be performed according to the methods described herein. In some examples, aspects of the operations of 620 may be performed by a color output manager as described with reference to FIGS. 2 through 5.

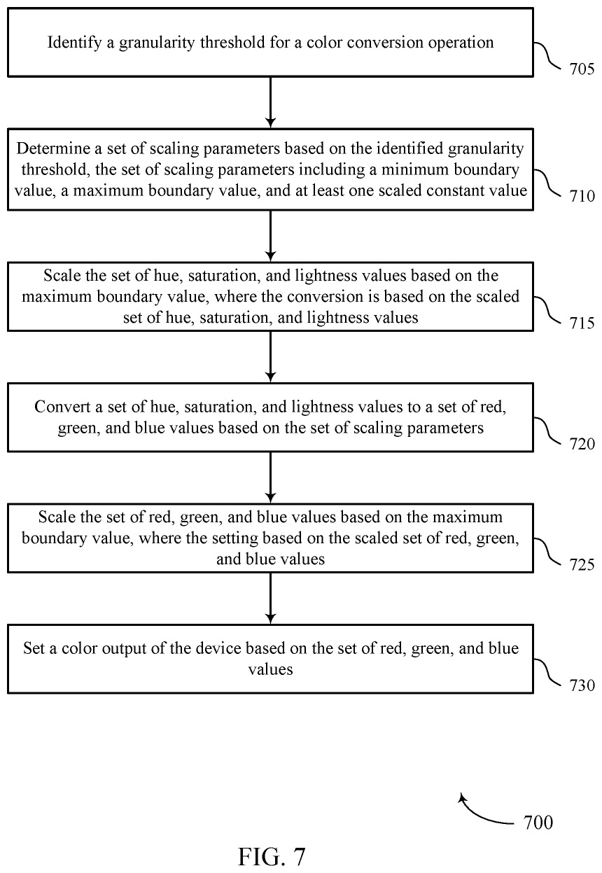

FIG. 7 shows a flowchart illustrating a method 700 that supports scaled conversion of HSL values to RGB values in accordance with aspects of the present disclosure. The operations of method 700 may be implemented by a device or its components as described herein. For example, the operations of method 700 may be performed by a color manager as described with reference to FIGS. 2 through 5. In some examples, a device may execute a set of instructions to control the functional elements of the device to perform the functions described below. Additionally or alternatively, a device may perform aspects of the functions described below using special-purpose hardware.

At 705, the device may identify a granularity threshold for a color conversion operation. The operations of 705 may be performed according to the methods described herein. In some examples, aspects of the operations of 705 may be performed by a conversion granularity manager as described with reference to FIGS. 2 through 5.

At 710, the device may determine a set of scaling parameters based on the identified granularity threshold, the set of scaling parameters including a minimum boundary value, a maximum boundary value, and at least one scaled constant value. The operations of 710 may be performed according to the methods described herein. In some examples, aspects of the operations of 710 may be performed by a scaling manager as described with reference to FIGS. 2 through 5.

At 715, the device may scale the set of hue, saturation, and lightness values based on the maximum boundary value, where the conversion is based on the scaled set of hue, saturation, and lightness values. The operations of 715 may be performed according to the methods described herein. In some examples, aspects of the operations of 715 may be performed by a scaling manager as described with reference to FIGS. 2 through 5.

At 720, the device may convert a set of hue, saturation, and lightness values to a set of red, green, and blue values based on the set of scaling parameters. The operations of 720 may be performed according to the methods described herein. In some examples, aspects of the operations of 720 may be performed by a color conversion manager as described with reference to FIGS. 2 through 5.

At 725, the device may scale the set of red, green, and blue values based on the maximum boundary value, where the setting based on the scaled set of red, green, and blue values. The operations of 725 may be performed according to the methods described herein. In some examples, aspects of the operations of 725 may be performed by a scaling manager as described with reference to FIGS. 2 through 5.

At 730, the device may set a color output of the device based on the set of red, green, and blue values. The operations of 730 may be performed according to the methods described herein. In some examples, aspects of the operations of 730 may be performed by a color output manager as described with reference to FIGS. 2 through 5.

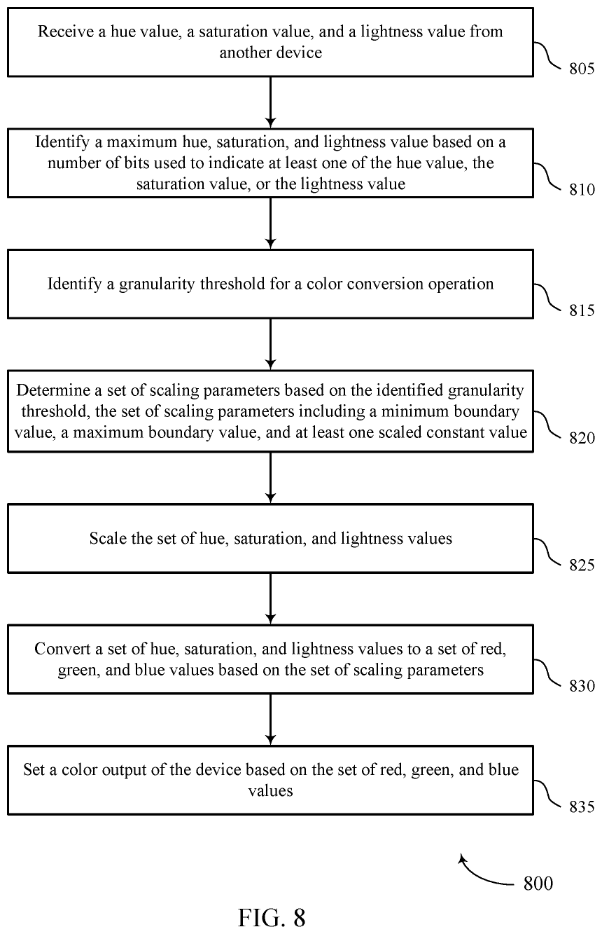

FIG. 8 shows a flowchart illustrating a method 800 that supports scaled conversion of HSL values to RGB values in accordance with aspects of the present disclosure. The operations of method 800 may be implemented by a device or its components as described herein. For example, the operations of method 800 may be performed by a color manager as described with reference to FIGS. 2 through 5. In some examples, a device may execute a set of instructions to control the functional elements of the device to perform the functions described below. Additionally or alternatively, a device may perform aspects of the functions described below using special-purpose hardware.

At 805, the device may receive a hue value, a saturation value, and a lightness value from another device. The operations of 805 may be performed according to the methods described herein. In some examples, aspects of the operations of 805 may be performed by a color output manager as described with reference to FIGS. 2 through 5.

At 810, the device may identify a maximum hue, saturation, and lightness value based on a number of bits used to indicate at least one of the hue value, the saturation value, or the lightness value. The operations of 810 may be performed according to the methods described herein. In some examples, aspects of the operations of 810 may be performed by a scaling manager as described with reference to FIGS. 2 through 5.

At 815, the device may identify a granularity threshold for a color conversion operation. The operations of 815 may be performed according to the methods described herein. In some examples, aspects of the operations of 815 may be performed by a conversion granularity manager as described with reference to FIGS. 2 through 5.

At 820, the device may determine a set of scaling parameters based on the identified granularity threshold, the set of scaling parameters including a minimum boundary value, a maximum boundary value, and at least one scaled constant value. The operations of 820 may be performed according to the methods described herein. In some examples, aspects of the operations of 820 may be performed by a scaling manager as described with reference to FIGS. 2 through 5.

At 825, the device may scale the set of hue, saturation, and lightness values (e.g., where the set of hue, saturation, and lightness values includes the received hue value, the saturation value, and the lightness value). The operations of 825 may be performed according to the methods described herein. In some examples, aspects of the operations of 825 may be performed by a scaling manager as described with reference to FIGS. 2 through 5.

At 830, the device may convert a set of hue, saturation, and lightness values to a set of red, green, and blue values based on the set of scaling parameters. The operations of 830 may be performed according to the methods described herein. In some examples, aspects of the operations of 830 may be performed by a color conversion manager as described with reference to FIGS. 2 through 5.

At 835, the device may set a color output of the device based on the set of red, green, and blue values. The operations of 835 may be performed according to the methods described herein. In some examples, aspects of the operations of 835 may be performed by a color output manager as described with reference to FIGS. 2 through 5.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for controlling light color at a device, comprising:
identifying a granularity threshold for a color conversion operation;
determining a set of scaling parameters based at least in part on the identified granularity threshold, the set of scaling parameters comprising a minimum boundary value, a maximum boundary value, and at least one scaled constant value;
converting a set of hue, saturation, and lightness values to a set of red, green, and blue values based at least in part on the set of scaling parameters; and
setting a color output of the device based at least in part on the set of red, green, and blue values.

2. The method of claim 1, further comprising:
scaling the set of hue, saturation, and lightness values based at least in part on the maximum boundary value, wherein the conversion is based at least in part on the scaled set of hue, saturation, and lightness values.

3. The method of claim 1, further comprising:
scaling the set of red, green, and blue values based at least in part on the maximum boundary value, wherein the setting based at least in part on the scaled set of red, green, and blue values.

4. The method of claim 1, further comprising:
determining a first scaled constant value of the at least one scaled constant value based at least in part on multiplying a first floating point parameter by the maximum boundary value, wherein the conversion is based at least in part on the first scaled constant value.

5. The method of claim 1, wherein the granularity threshold comprises a number of decimal place values associated with an accuracy for the color conversion operation.

6. The method of claim 5, wherein the maximum boundary value is determined based at least in part on the number of decimal place values.

7. The method of claim 1, further comprising:
identifying a floating point operation, wherein the set of scaling parameters is determined based at least in part on the identified floating point operation.

8. The method of claim 1, further comprising:
receiving a hue value, a saturation value, and a lightness value from another device, wherein the set of hue, saturation, and lightness values comprises the hue value, the saturation value, and the lightness value;
identifying a maximum hue, saturation, and lightness value based at least in part on a number of bits used to indicate at least one of the hue value, the saturation value, or the lightness value; and
scaling the set of hue, saturation, and lightness values.

9. The method of claim 8, wherein scaling the set of hue, saturation, and lightness values comprises:
multiplying each of the hue value, the saturation value, and the lightness value by a ratio of the maximum boundary value and the maximum hue, saturation, and lightness value, wherein the conversion is based at least in part on the scaled set of hue, saturation, and lightness values.

10. An apparatus for controlling light color at a device, comprising:
a processor,
memory in electronic communication with the processor; and
instructions stored in the memory and executable by the processor to cause the apparatus to:
identify a granularity threshold for a color conversion operation;
determine a set of scaling parameters based at least in part on the identified granularity threshold, the set of scaling parameters comprising a minimum boundary value, a maximum boundary value, and at least one scaled constant value;
convert a set of hue, saturation, and lightness values to a set of red, green, and blue values based at least in part on the set of scaling parameters; and
set a color output of the device based at least in part on the set of red, green, and blue values.

11. The apparatus of claim 10, wherein the instructions are further executable by the processor to cause the apparatus to:
scale the set of hue, saturation, and lightness values based at least in part on the maximum boundary value, wherein the conversion is based at least in part on the scaled set of hue, saturation, and lightness values.

12. The apparatus of claim 10, wherein the instructions are further executable by the processor to cause the apparatus to:
scale the set of red, green, and blue values based at least in part on the maximum boundary value, wherein the setting based at least in part on the scaled set of red, green, and blue values.

13. The apparatus of claim 10, wherein the instructions are further executable by the processor to cause the apparatus to:
determine a first scaled constant value of the at least one scaled constant value based at least in part on multiplying a first floating point parameter by the maximum boundary value, wherein the conversion is based at least in part on the first scaled constant value.

14. The apparatus of claim 10, wherein the granularity threshold comprises a number of decimal place values associated with an accuracy for the color conversion operation.

15. The apparatus of claim 14, wherein the maximum boundary value is determined based at least in part on the number of decimal place values.

16. The apparatus of claim 10, wherein the instructions are further executable by the processor to cause the apparatus to:
identify a floating point operation, wherein the set of scaling parameters is determined based at least in part on the identified floating point operation.

17. The apparatus of claim 10, wherein the instructions are further executable by the processor to cause the apparatus to:
receive a hue value, a saturation value, and a lightness value from another device, wherein the set of hue, saturation, and lightness values comprises the hue value, the saturation value, and the lightness value;
identify a maximum hue, saturation, and lightness value based at least in part on a number of bits used to indicate at least one of the hue value, the saturation value, or the lightness value; and
scale the set of hue, saturation, and lightness values.

18. The apparatus of claim 17, wherein the instructions to scale the set of hue, saturation, and lightness values are executable by the processor to cause the apparatus to:
multiply each of the hue value, the saturation value, and the lightness value by a ratio of the maximum boundary value and the maximum hue, saturation, and lightness value, wherein the conversion is based at least in part on the scaled set of hue, saturation, and lightness values.

19. An apparatus for controlling light color at a device, comprising:
means for identifying a granularity threshold for a color conversion operation;
means for determining a set of scaling parameters based at least in part on the identified granularity threshold, the set of scaling parameters comprising a minimum boundary value, a maximum boundary value, and at least one scaled constant value;
means for converting a set of hue, saturation, and lightness values to a set of red, green, and blue values based at least in part on the set of scaling parameters; and
means for setting a color output of the device based at least in part on the set of red, green, and blue values.

20. The apparatus of claim 19, further comprising:
means for scaling the set of hue, saturation, and lightness values based at least in part on the maximum boundary value, wherein the conversion is based at least in part on the scaled set of hue, saturation, and lightness values.
